(19) United States
(12) Patent Application Publication
(10) Pub. No.: US 2009/0221270 A1
(43) Pub. Date: Sep. 3, 2009

(54) METHOD OF PROVIDING MOBILITY INFORMATION IN A COMMUNICATION SYSTEM

(75) Inventor: Toby Kier Proctor, Wilts (GB)

Correspondence Address: LERNER GREENBERG STEMER LLP, P O BOX 2480, HOLLYWOOD, FL, 33022-2480, US

(73) Assignee: Nokia Siemens Networks GmbH & Co., KG, Munchen (DE)

(21) Appl. No.: 12/278,356

(22) PCT Filed: Jan. 31, 2007
(86) PCT No.: PCT/GB07/50047

§ 371 Date: Feb. 17, 2009

(30) Foreign Application Priority Data
Feb. 8, 2006 (GB) 0602421.0

(51) Int. Cl. H04M 3/42; H04W 4/00

(52) U.S. Cl. 455/414.1; 455/422.1

(57) ABSTRACT

A method of providing mobility information in a mobile communication system comprises setting a mobility flag on initiation of a user subscription representing (5) mobility type in a network (3) for each subscriber. On receiving a request (7) from a subscriber to operate in the network, the mobility flag (10) of the subscriber is checked (12) and the subscriber is instructed to use an appropriate configuration for communication on the network according to the mobility flag set for that subscriber

### CLAIM FOR PRIORITY

This application is a national stage application of PCT/GB2007/050047, filed Jan. 31, 2007, which claims the benefit of priority to Application No. 0602421.0, filed Feb. 8, 2006, the contents of which hereby incorporated by reference.

### TECHNICAL FIELD OF THE INVENTION

This invention relates to a method of providing mobility information in a communication system, particularly for wireless communications such as the 3rd generation partnership project (3GPP).

### BACKGROUND OF THE INVENTION

Current 3GPP wireless systems make no distinction in user subscriptions between subscriptions which require full mobility handling, such as mobile phones in which handover, context transfer and other procedures must be performed to achieve quality of service requirements and types of users which have more limited requirements for mobility such as laptops which will tend to use the wireless communication system in a “nomadic” form, and hence will accept a loss of communication and reconnect at a new point in the network to continue any data transfer, or static access points for broadband wireless access systems, where there is a no mobility requirement, and hence no requirement to provide session continuation after mobility to another cell in the wireless communication system.

As a consequence, the information stored at various nodes and the procedures used, e.g. taking measurements, for mobility handling are the same for all users regardless of whether it is expected that mobility is required to be seamless, i.e. requiring handover, or some loss of connection can be tolerated. This leads to a waste of resources and limitations on how much traffic can be served because of the unnecessary signaling taking place. In the long term evolution (LTE) of 3GPP, it is desirable to improve efficiency.

### SUMMARY OF THE INVENTION

In accordance with one embodiment of the present invention, there is a method of providing mobility information in a communication system including setting a mobility flag on initiation of a user subscription representing mobility type in a network for each subscriber; on receiving a request from a subscriber to operate in the network, checking the mobility flag of the subscriber; and instructing the subscriber to use an appropriate configuration for communication on the network according to the mobility flag set for that subscriber. The present invention allows a user to subscribe to a service appropriate to their needs, rather than the one size fits all approach of conventional methods. This frees up resources, which can be further encouraged by differential pricing by the network operator.

In one aspect of the invention, the mobility type includes one of full, nomadic and fixed. For a user requiring seamless transitions, only full mobility will be acceptable, but for users who can accept some loss of connection on transfer, a nomadic subscription may be more suitable. Users within a fixed location area, such as a particular cell or geographical area, can sign up for a fixed mobility type.

In another aspect of the invention, a fixed mobility type subscriber is allocated a location area, wherein any attempt to communicate outside that location area is notified to a predetermined destination.

This is an added feature which might be useful for large scale operations, such as open plan offices, if there are concerns about physical security, so that any attempt to use a machine outside its approved location area would be notified to a central resource, such as the IT department.

In another aspect of the invention, a controlling entity within the radio access network is provided with the subscriber information on receipt of the request to operate from an entity within the operator core network.

In still another aspect of the invention, the controlling entity informs the subscriber of its mobility type. The information on subscriber type is accessible to the network, rather than held on the subscriber device.

In yet another aspect of the invention, the controlling entity provides regular broadcasts to all subscribers within range, giving configuration information for the different mobility types. Preferably, the controlling entity provides separate information to each subscriber at initial system registration, giving configuration information for the different mobility types.

The controlling entity can provide the information by a direct or point to point transmission to the subscriber, but since the same data needs to be passed to many users, it is generally more efficient to provide it via a broadcast, having used a direct response at initial system registration to the subscriber indicating the mobility type of the subscriber.

In another aspect of the invention, the controlling entity provides a radio resource management function.

In one aspect of the invention, the controlling entity is either the access gateway or the base station. The precise location of the function in the network architecture will vary according to the specific structure of the network.

In another aspect of the invention, the mobility flag is set in a home location register. From the home location register, the network can request the data which has been set and communicate it as necessary to other parties, or the subscriber itself.

In still another aspect of the invention, the communication system is a global system for mobile communication (GSM) system, but the method is applicable to any system in which a subscriber makes use of a wireless communication system to send and receive data and/or voice and such a user may move around the network connecting to a multitude of base stations over time.

### BRIEF DESCRIPTION OF THE DRAWINGS

An example of a method of providing mobility information in a communication system will now be described with reference to the accompanying drawings in which:

FIG. 1 is an exemplary block diagram of the entities involved in using the method of the present invention.

FIG. 2 illustrates an example of the signaling between a subscriber and the network to enable operation on the network using a method according to the invention.

### DETAILED DESCRIPTION OF THE INVENTION

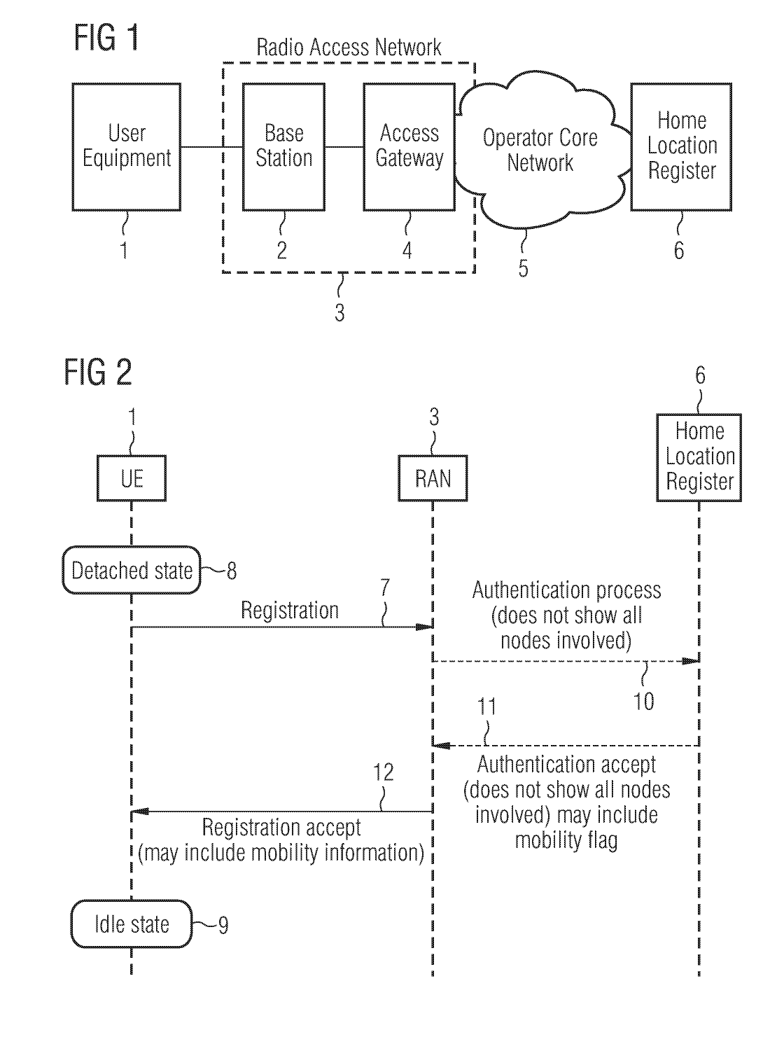

A typical communication set-up for the present invention is shown in FIG. 1. A terminal, or user equipment (UE) 1, such as a mobile station (MS), or wireless broadband modem connects to a wireless communication system, in this example, represented by a base station 2 of a radio access network (RAN) 3. There may be many UEs 1 connected to a single base station 2, and the base station may include the RRM functions as described hereinafter. The base station is a node at the edge of a wireless network, and there may be many base stations connected to an access gateway 4, which is a node providing a termination point for non access stratum signaling, i.e. that not directly related to radio resource management. The access gateway connects to an operator core network 5, and there can be many access gateways connected to the operator core network.

The operator core network 5 connects the RAN 2 to a home location register (HLR) 6, which manages mobile subscribers and stores an international mobile subscriber identity (IMSI), an MS phone number, any current visited location register address and subscriber data, including a mobility flag. A visiting location register (VLR) is required in the case that the UE is roaming in another operator network in which case it acts as a proxy between the UE, the visited network and the home network, relaying subscription information to the visited network.

A flag is provided in a user subscription and stored in the HLR. The flag is provided to a radio resource management (RRM) function on request and to any other entities where it is required by the system, during a transition from detached state to LTE_Idle state. For example, when the user switches on and attempts to register for communication using the network, then the RRM function checks that the user is a valid subscriber and authenticates. Thereafter, the network checks the mobility type or status of the user. Thus, the RRM function is able to distinguish between static, nomadic and fully mobile UEs which have different requirement with respect to the provision of a seamless mobility experience. This distinction enables the RRM function to determine whether or not to configure particular functions and/or procedures in the UE which are required for mobility, for example measurement reports. By distinguishing between mobile and nomadic UEs having full, nomadic or fixed mobility types, the system is able to run more efficiently by reducing the amount of radio traffic due to signaling of data, such as the mobility measurement reports.

In addition, a simpler UE concept is then possible which reduces the time taken to get new products to market because it is not necessary to implement any procedures related to mobility handling when their user profile is such that they do not require that level of mobility quality. This allows a quicker rollout of the new network.

Memory usage for UEs or network nodes for which mobility is not configured is also reduced since the configuration of measurements takes resources, and the battery life of the UE is improved since making measurements costs power resources in the UE. The different classes of user subscription allow mobile network operators to enable different contract types depending on user mobility requirements.

A change in mobility status, e.g. an upgrade from nomadic to full, requires a change in the users contract with its operator, which can carried out in any convenient way, such as by direct communication to the operator, via the internet or phone.

FIG. 2 illustrates operation of the method of the present invention in more detail. The UE 1 performs registration 7 in the network to move from detached state, i.e. not known in the network, to idle state, i.e. known in the network, but not transmitting data. This is the first step the mobile 1 performs when attaching to the network 2. The access gateway 4 begins an authentication procedure 10 which indirectly checks for subscriber information with the HLR 6. The HLR responds 11 to the RAN 2 with subscriber information and at least subscriber mobility information is provided to the access gateway 4. The registration is accepted 12 and provided to the UE 1, along with any necessary mobility subscription information If necessary, the registration information is provided to the base station 3. This may be at registration 7 or when the UE 1 begins transmission of data.

Although this example has been described with registration and authentication being routed via the RAN 2, this will not always be the case. In LTE there are various nodes which may process such request, such as the Node B, base station, the access gateway or any other node in the operator core network 5 and the invention is equally applicable to systems operating in that way.

1. A method of providing mobility information in a mobile communication system, comprising:
setting a mobility flag on initiation of a user subscription representing mobility type in a network for each subscriber;
on receiving a request from a subscriber to operate in the network, checking the mobility flag of the subscriber; and
instructing the subscriber to use an appropriate configuration for communication on the network according to the mobility flag set for that subscriber

2. A method according to claim 1, wherein the mobility type comprises one of full, nomadic and fixed.

3. A method according to claim 2, wherein a fixed mobility type subscriber is allocated a location area; and wherein any attempt to communicate outside that location area is notified to a predetermined destination.

4. A method according to claim 1, wherein a controlling entity within the radio access network is provided with the subscriber information on receipt of the request to operate from an entity within an operator core network.

5. A method according to claim 4, wherein the controlling entity informs the subscriber of its mobility type.

6. A method according to claim 4, wherein the controlling entity provides regular broadcasts to all subscribers within range, giving configuration information for the different mobility types.

7. A method according to claim 4, wherein the controlling entity provides separate information to each subscriber at an initiation of the user subscription.

8. A method according to claim 1, wherein the controlling entity provides a radio resource management function.

9. A method according to at least claim 4, wherein the controlling entity is one of an access gateway or a base station.

10. A method according to claim 1, wherein the mobility flag is set in a home location register.

11. A method according to claim 1, wherein the communication system is a global system for mobile communication (GSM) system.
